(19) United States
(12) Patent Application Publication
(10) Pub. No.: US 2024/0211454 A1
(43) Pub. Date: Jun. 27, 2024

(54) CALCULATION DEVICE, CALCULATION METHOD, AND RECORDING MEDIUM

(71) Applicant: Shinji FURUSHO, Kanagawa (JP)

(72) Inventor: Shinji FURUSHO, Kanagawa (JP)

(21) Appl. No.: 18/588,343

(22) Filed: Feb. 27, 2024

Related U.S. Application Data
(63) Continuation of application No. PCT/JP2021/031784, filed on Aug. 30, 2021.

(51) Int. Cl. G06F 16/22

(52) U.S. Cl. CPC G06F 16/22

(57) ABSTRACT

A calculation device includes a processor; and a memory storing program instructions that cause the processor to decompose an ordered record selection component S₍ₙ₎^{(N)} into a record selection component L₍ₙ₎^{(N)} and a record order component P₍ₙ₎⁽ⁿ⁾. The ordered record selection component S₍ₙ₎^{(N)} is an ordered set including n (0≤n≤N) elements selected from a record number set including integers from Q to Q+N−1 (Q is a predetermined integer and N is a predetermined integer greater than or equal to 1). The record selection component L₍ₙ₎^{(N)} is a set including n elements selected from the record number set. The record order component P₍ₙ₎⁽ⁿ⁾ represents an order of the elements of the record selection component L₍ₙ₎^{(N)}. The processor decomposes the ordered record selection component S₍ₙ₎^{(N)} by using a predetermined operation between the record selection component L₍ₙ₎^{(N)} and the record order component P₍ₙ₎⁽ⁿ⁾.

### CROSS-REFERENCE TO RELATED APPLICATIONS

This application is a continuation application of International Application No. PCT/JP2021/031784 filed on Aug. 30, 2021, and designating the U.S., the entire contents of which are incorporated herein by reference.

### BACKGROUND

### 1. Technical Field

The present disclosure relates to a calculation device, a calculation method, and a recording medium.

### 2. Description of the Related Art

In recent years, with the development of various sensor devices, observation devices, and the like, a large amount of data (what is called big data) representing sensing results, observation results, and the like can be obtained. Because these big data are obtained as tabular data, there are needs to perform desired analysis using various operations (for example, search, sort, aggregation, relational algebra operation, and the like) on the tabular data. In response to such needs, a technique of achieving various operations at high speed by decomposing the tabular data into a component group mainly including natural numbers is known (see Non-Patent Document 1).

### RELATED ART DOCUMENT

### Non-Patent Document

Non-Patent Document 1: Shinji Furusho, Atsushi Iizawa, Tadashi Nagano, Yukio Yamamoto, Shuichi Hayabe, Yoshikatsu Ozamoto, Masahide Kobayashi, “Accelerating Big Data Processing in Space Sciences with Natural Number Index (NNI)”, Japan Aerospace Exploration Agency research and development report: Journal of Space Science Informatics Japan: Volume 10, JAXA RR 20 010,1 65 (2021 02 22), Material No.: AA2030022001, Report No.: JAXA-RR-20-010

### SUMMARY

According to one embodiment of the present disclosure, a calculation device includes a processor; and a memory storing program instructions that cause the processor to decompose an ordered record selection component S₍ₙ₎^{(N)} into a record selection component L₍ₙ₎^{(N)} and a record order component P₍ₙ₎⁽ⁿ⁾. The ordered record selection component S₍ₙ₎^{(N)} is an ordered set including n (0≤n≤N) elements selected from a record number set including integers from Q to Q+N−1 (Q is a predetermined integer and N is a predetermined integer greater than or equal to 1). The record selection component L₍ₙ₎^{(N)} is a set including n elements selected from the record number set. The record order component P₍ₙ₎⁽ⁿ⁾ represents an order of the elements of the record selection component L₍ₙ₎^{(N)}. The program instructions cause the processor to decompose the ordered record selection component S₍ₙ₎^{(N)} by using a predetermined operation between the record selection component L₍ₙ₎^{(N)} and the record order component P₍ₙ₎⁽ⁿ⁾.

### BRIEF DESCRIPTION OF THE DRAWINGS

FIG. 1 is a diagram illustrating a hardware configuration of an index calculation device according to an embodiment;

FIG. 2 is a diagram illustrating a functional configuration of the index calculation device according to the embodiment;

FIG. 3 is a diagram for explaining an example of an ordered record selection component;

FIG. 4 is a first flowchart for explaining an example of a process of decomposing the ordered record selection component;

FIG. 5 is a diagram for explaining an example of a Map array after initialization;

FIG. 6 is a diagram for explaining an example of updating of the Map array;

FIG. 7 is a diagram for explaining an example of creation of a record selection component and an inverse of a record order component;

FIG. 8 is a diagram for explaining an example of creation of the record order component;

FIG. 9 is a second flowchart for explaining an example of a process of decomposing the ordered record selection component;

FIG. 10 is a diagram for explaining an example of sorting of a position array of the ordered record selection component;

FIG. 11 is a diagram for explaining examples of tables T₀, T₁, and T₂;

FIG. 12 is a diagram for explaining an example of a process of displaying a reverse sort result;

FIG. 13 is a diagram for explaining examples of internal sorting and creation of chronologically-accumulated values;

FIG. 14 is a diagram for explaining an example of a display of the table T₂ and the chronologically-accumulated values; and FIG. 15 is a diagram for explaining an example of a symmetric array other than a base-O array.

### DETAILED DESCRIPTION

Here, in the technique described in Non-Patent Document 1, the tabular data is uniquely decomposed into a component group including a component related to a record and a component related to a column. Among these, the component related to the record is an ordered set called OrdSet (Ordered Set), and is used to store record numbers of a record group hit in a search, record numbers of a record group rearranged by sorting, and the like. A mechanism (an algorithm group) for achieving various operations such as search, sort, aggregation, relational algebra calculation, and the like using such a component group is called a natural number index.

In the natural number index, OrdSet may be used as is, or OrdSet may be decomposed into a component (a selection component) representing a record number selected from original tabular data and a component (an order component) representing the order of record numbers. Thus, it is preferable that such decomposition can be performed at high speed.

According to at least one embodiment of the present disclosure, an ordered set can be decomposed into a selection component and an order component at high speed.

In the following, an embodiment of the present invention will be described.

### <Natural Number Index>

The tabular data has a data structure including N records and M columns. Each of the columns has N values of the same data type, and the i-th column has Ki different values. Hereinafter, N, M, and Ki are used in this sense without any special note given. Here, when a target column is identified, Ki is abbreviated as K.

Arbitrary tabular data can be uniquely decomposed into a component related to the record and a component related to the column. A mechanism (an algorithm group) for achieving various operations, such as search, sort, aggregation, relational algebra calculation, and the like, using a group of these components, is a natural number index (NNI).

The component related to the record is an ordered set called OrdSet, and the component related to the column is sets called a sorted value list (SVL) component and a natural numbered column (NNC) component. Each of these components is represented by a one-dimensional array, and the elements of the components are values of the same data type. Here, the sorted value list component and the natural numbered column component are obtained for each column.

Additionally, when the component related to the record and the component related to the column are combined, the original tabular data can be completely restored. Therefore, operations corresponding to various operations on the original tabular data, such as search, sort, aggregation, relational algebra calculation, and the like, are uniquely determined also on the component group including the component related to the record and the component related to the column (see Non-Patent Document 1). That is, there is an approach in which processing on the tabular data is replaced with an operation on the component group. This is the natural number index. Here, for the advantage of using the natural number index and the like, see Non-Patent Document 1.

### <Type of Array>

Each of the components used in the natural number index is held as a one-dimensional array of a base 0. The element of the array may take on various data types, example of which include an integer, a floating point number, and a string. Therefore, to clearly indicate the type of the element of the array, the array is also referred to as a natural number array, a string array, or the like. Most of the components (that is, one-dimensional arrays) used in the natural number index are a complete sequential number N array having natural numbers from 0 to N−1, called a complete sequential number N to be described later, as elements.

### <<Notation of Array>>

First, the notation of the array will be described.

A one-dimensional array A having a size n is represented as A₍ₙ₎. The i-th element of the one-dimensional array A₍ₘ₎ is represented by A₍ₘ₎[i]. A₍ₙ₎=(A₍ₙ₎ [0], A₍ₙ₎ [1], . . . , A₍ₙ₎ [n−1]).

To clearly indicate that the elements of the one-dimensional array A are the complete sequential number N, the one-dimensional array A is expressed as A^{(N)}. When the size of the one-dimensional array A is n and the elements thereof are the complete sequential number N, the one-dimensional array A is expressed as A₍ₙ₎^{(N)}. Here, n and N are independent of each other.

### <<Complete Sequential Number N>>

Consecutive natural numbers from 0 to N−1 are referred to as the complete sequential number N. Given an element i of the complete sequence number N, the total number of different values (i.e., N), the number of values less than i (i.e., i), and the number of values greater than i (i.e., N-i-1) are immediately found.

For example, when the element 5 belonging to the complete sequential number 7 is given, it is understood that the total number of different values is seven, that is 0 to 6, the number of values less than 5 is five, that is 0 to 4, and the number of values greater than 5 is 1, that is 6.

### <<Complete Sequential Number N Array, Symmetric Array, and the Like>>

A one-dimensional array whose elements are the complete sequential number N is called a complete sequential number N array. That is, a value of an arbitrary element A^{(N)} [i] of the complete sequence number N array A^{(N)} is any number from 0 to N−1.

When a complete sequence N array having a size N satisfies P_{(N)}^{(N)} [i]≈P_{(N)}^{(N)} [j], if i≈j, P_{(N)}^{(N)} is called a symmetric array N. That is, the symmetric array N is a one-dimensional array that has a size N and that has values from 0 to N−1 as elements without duplication. It is also conceivable that the symmetric array represents a permutation for values from 0 to N−1. Here, the symmetric array forms a group with respect to an index operator “.” described later.

Additionally, when the array A^{(N)} is the complete sequential number N array and satisfies A^{(N)} [i]≤A^{(N)} [j] if i<j, A^{(N)} is called a non-decreasing array. It is often necessary to read A^{(N)} [−1] from the non-decreasing array A^{(N)}. In this case, A^{(N)} [−1]=0 is determined in advance.

In the non-decreasing array, when A^{(N)} [i]<A^{(N)} [j] if i<j is satisfied, A^{(N)} is called an increasing array.

### <Index Operator>

An index operator “ ” for G×G→G is defined below, where G is a set of one-dimensional arrays.

$${C}_{( m )} ≡ {A}_{( n )} \cdot {B}_{( m )} = ( {A}_{( n )} [ {B}_{( m )} [ 0 ] ] , {A}_{( n )} [ {B}_{( m )} [ 1 ] ] , … , {A}_{( n )} [ {B}_{( m )} [ m - 1 ] ] )$$

Here, the one-dimensional array B(m) on the right side of the index operator is a complete sequential number n array.

The index calculation has the characteristics indicated in (1), (2), and (3) below.
(1) The associative law is established. That is, (A₍ₙ₎·B₍ₘ₎)·C₍₁₎=A₍ₙ₎·(B₍ₘ₎·C₍₁₎) is established for the one-dimensional arrays A(n), B(m), C(1) E G. Here, B₍ₘ₎ is a complete sequential number n array, and C(1) is a complete sequential number m array.
(2) The size of the one-dimensional array representing the operation result is the size of the one-dimensional array on the right side of the index operator (that is, the operand on the right side).
(3) The data type of the element of the one-dimensional array representing the operation result is the data type of the element of the one-dimensional array on the left side of the index operator (that is, the operand on the left side).

Additionally, when an arbitrary one-dimensional array P_{(N)} ∈G is a symmetric array, (G,·) forms a group. At this time, the identity element is E=(0, 1, . . . , N−1), and the inverse of P is P⁻¹ where P⁻¹ [j]=i if P[i]=j.

### <Component Group Used in Natural Number Index>

As described above, in the natural number index, the component group including the component related to the record and the component related to the column is used.

### <<Component Related to Record>>

The following description assumes that the tabular data has N records. The first record of the tabular data is identified by a record number 0, and the last record is identified by a record number N−1. This record number is a complete sequential number N. By using the record number, the record can be accessed at high speed and the positional relationship between the records can be grasped. For example, a section from a 100th element to a 200th element can be grasped.

Any result of searching and sorting performed on tabular data can be represented using a complete sequential number N array S₍ₙ₎^{(N)} having a size n (≤N) with no duplicate values (i.e., S₍ₙ₎^{(N)} where S₍ₙ₎^{(N)} (i)≈S₍ₙ₎^{(N)} [j] is satisfied if 0≤n≤N and i≈j). This array S is OrdSet, but will be hereinafter referred to as an ordered record selection component. For example, S₍₃₎^{(N)}=(3, 0, 4) is an ordered set in which third, zeroth, and fourth records are selected from the N records and arranged in this order.

In an algorithm group for achieving various operations in the natural number index (for example, search, sort, aggregation, relational algebra operation, and the like), the ordered record selection component S is usually used as is, but may be decomposed into a record selection component L and a record order component P as S₍ₙ₎^{(N)}=L₍ₙ₎^{(N)}·P₍ₙ₎⁽ⁿ⁾ and used (see Non-Patent Document 1). At this time, the record selection component L is an increasing array, and the record order component P is a symmetric array. For example, when S=(3, 0, 4), L=(0, 3, 4) and P=(1, 0, 2).

In the embodiment described later, a case where when the ordered record selection component S₍ₙ₎^{(N)} is given, the ordered record selection component S₍ₙ₎^{(N)} is decomposed at high speed as S₍ₙ₎^{(N)}=L₍ₙ₎^{(N)}·P₍ₙ₎⁽ⁿ⁾ (more specifically, a case where the ordered record selection component S₍ₙ₎^{(N)} is decomposed in the order of O (n) or O(n×log (n)) time complexity will be described. This can increase the speed of the algorithm group for achieving various operations in the natural number index.

### <<Component Related to Column>>

The column of the tabular data can be regarded as a non-natural number array C_{(N)} holding N values. When K different values included in C_{(N)} are extracted and stored in ascending order, a sorted value list component SVL is obtained. SVL is also a non-natural number array. Next, when each element of C_{(N)} is replaced with a storage position (0, 1, . . . , K−1) on SVL, a natural numbered column component NNC is obtained. NNC is a complete sequential number K array. At this time, C_{(N)}=SVL_{(K)}·NNC_{(N)}^{(K)} is established.

For example, when C₍₆₎=(Bob, Cathy, Alice, Bob, Bob, Cathy), SVL₍₃₎=(Alice, Bob, Cathy) and NNC₍₆₎⁽³⁾=(1, 2, 0, 1, 1, 2).

### <Reverse Sort>

When (G,·) forms a group, with respect to arbitrary record order components P₁, P₂ ∈G, there is an element Pₛ ∈G that achieves the same operation as sorting.

That is, there is Pₛ that satisfies the following expression.

$${P}_{S} : {P}_{1} ↦ {P}_{2} \qquad [ Ex . 1 ]$$

This Pₛ is called a sort from P₁ to P₂, and its inverse Pₛ⁻¹ is called a reverse sort.

In general, because the group (G,·) is non-commutative, in Pₛ, there are P_{SL} for obtaining P₂ by performing an index calculation on P₁ from the left and P_{SR} for obtaining P₂ by performing an index calculation on P₁ from the right.

Specifically, there are P_{SL} and P_{sR} such that P_{SL} P₁=P₂ and P₁·P_{SR}=P₂. Thus, it is found that the following is established.

$${P}_{S L} = {P}_{2} \cdot {P}_{1}^{- 1}$$

$${P}_{SL}^{- 1} = {P}_{1} \cdot {P}_{2}^{- 1}$$

$${P}_{SR} = {P}_{1}^{- 1} \cdot {P}_{2}$$

$${P}_{SR}^{- 1} = {P}_{2}^{- 1} \cdot {P}_{1}$$

Further, it is found that the following is established.

$${P}_{S L} = {P}_{2} \cdot {P}_{SR} \cdot {P}_{2}^{- 1}$$

$${P}_{SR} = {P}_{2}^{- 1} \cdot {P}_{S L} \cdot {P}_{2}$$

Among P_{sL} and P_{sR} described above, only P_{sR} can be used to perform an index calculation on a non-natural number array, and therefore, the P_{sR} will be hereinafter referred to as Pₛ. For example, when P_{SL}=P_{SR}=(4, 3, 2, 1, 0), the calculation can be performed as (Alice, Bob, Cathy, Dolly, Eric)·P_{SR}=(Eric, Dolly, Cathy, Bob, Alice), but P_{SL}·(Alice, Bob, Cathy, Dolly, Eric) cannot be calculated.

In the embodiment described later, a case in which the sort Pₛ is applied to a column of tabular data, the reverse sort Pₛ⁻¹ is created and the reverse sort Pₛ⁻¹ is applied to a one-dimensional array having accumulated values of the column after sorting as elements, and the result is displayed will be described. This can display the accumulated values in a form corresponding to the tabular data while maintaining the display of the original tabular data.

### EMBODIMENT

As an embodiment, an index calculation device 10 will be described below. When the ordered record selection component S is given, the index calculation device 10 decomposes the ordered record selection component S at high speed as S=L·P, calculates chronologically-accumulated values of sales from a result of applying the sort Pₛ to tabular data in the time order, applies the reverse sort Pₛ⁻¹ to the chronologically-accumulated values, and displays the tabular data before applying the sort Pₛ and the chronologically-accumulated values after applying the reverse sort Pₛ⁻¹.

### <Hardware Configuration of Index Calculation Device 10>

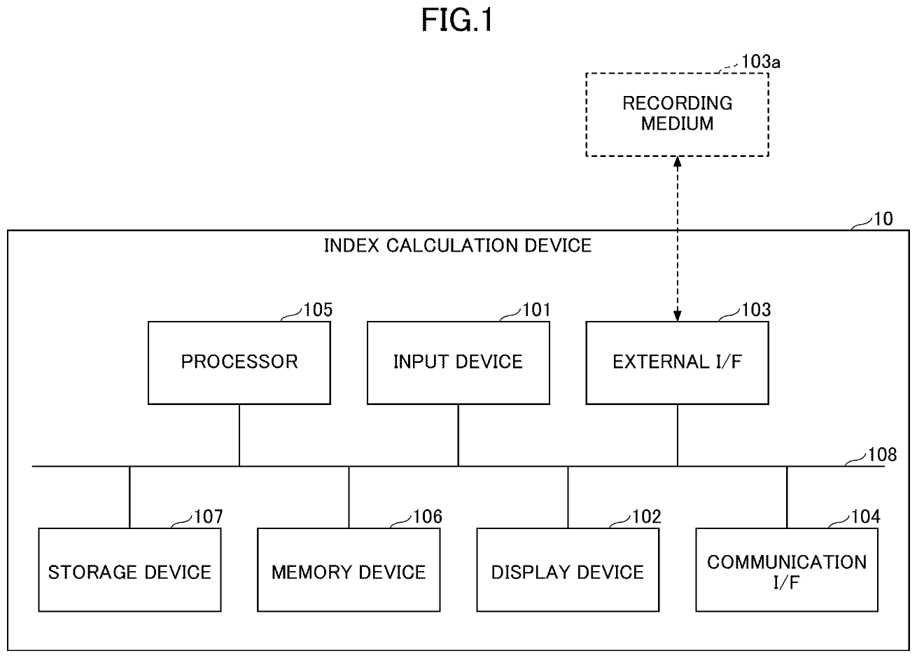

FIG. 1 illustrates a hardware configuration of the index calculation device 10 according to the present embodiment. As illustrated in FIG. 1, the index calculation device 10 in the present embodiment is implemented in a hardware configuration of a general computer or computer system, and includes an input device 101, a display device 102, an external interface (I/F) 103, a communication I/F 104, a processor 105, a memory device 106, and a storage device 107. These hardware components are communicably connected to each other via a bus 108.

Examples of the input device 101 include a keyboard, a mouse, a touch panel, various physical buttons, and the like. The display device 102 is, for example, a display, a display panel, or the like.

The external I/F 103 is an interface with an external device, such as a recording media 103a. The index calculation device 10 can read from and write to the recording media 103a via the external I/F 103. Here, examples of the recording media 103a include a flexible disk, a compact disc (CD), a digital versatile disk (DVD), a secure digital memory card (SD memory card), a universal serial bus (USB) memory card, and the like.

The communication I/F 104 is an interface for connecting the index calculation device 10 to a communication network. The processor 105 is, for example, one or a combination of various arithmetic devices, such as a central processing unit (CPU) and a graphics processing unit (GPU). Here, when the processor 105 is a CPU, the processor 105 may be a multi-core CPU. The memory device 106 is, for example, a main storage device, such as a random access memory (RAM). The storage device 107 is an auxiliary storage device, such as a hard disk drive (HDD) or a solid state drive (SSD).

The index calculation device 10 in the present embodiment has the hardware configuration illustrated in FIG. 1 to achieve various processes described later. Here, the hardware configuration illustrated in FIG. 1 is an example, and the index calculation device 10 may include, for example, multiple processors 105, multiple memory devices 106, or multiple storage devices 107. Additionally, the index calculation device 10 may include various hardware components other than the illustrated hardware components.

### <Functional Configuration of Index Calculation Device 10>

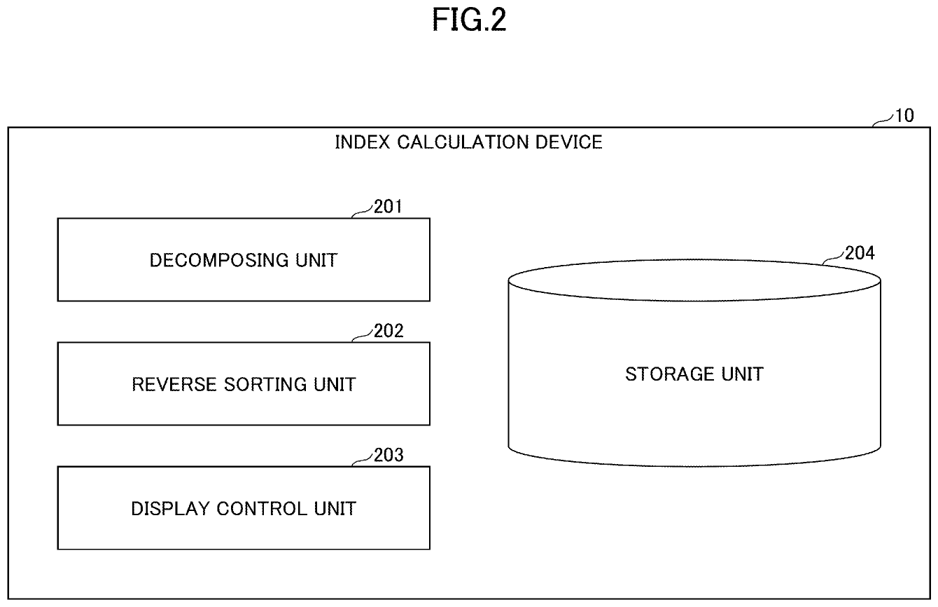

FIG. 2 illustrates a functional configuration of the index calculation device 10 in the present embodiment. As illustrated in FIG. 2, the index calculation device 10 according to the present embodiment includes a decomposing unit 201, a reverse sorting unit 202, a display control unit 203, and a storage unit 204. Here, the decomposing unit 201, the reverse sorting unit 202, and the display control unit 203 are implemented by, for example, the processor 105 executing one or more programs installed in the index calculation device 10. Additionally, the storage unit 204 is implemented by the memory device 106, the storage device 107, or both. However, the storage unit 204 may be implemented by, for example, a storage device (for example, a database server, a network attached storage (NAS), or the like) connected to the index calculation device 10 via the communication network.

When the ordered record selection component S₍ₙ₎^{(N)} is given, the decomposing unit 201 decomposes S₍ₙ₎^{(N)} as S₍ₙ₎^{(N)}=L₍ₙ₎^{(N)}·P₍ₙ₎⁽ⁿ⁾. At this time, the decomposing unit 201 performs decomposition by different methods depending on whether n is sufficiently less than N (n<<N). Hereinafter, a case where n is not sufficiently less than N will be described as n˜N. Here, whether a relationship between n and N satisfies n<<N can be determined as appropriate.

The reverse sorting unit 202 creates a reverse sort Pₛ⁻¹ for a sort Pₛ. The display control unit 203 displays the tabular data, the result of applying the reverse sort Pₛ⁻¹ to a one-dimensional array, and the like.

The storage unit 204 stores various information, such as the ordered record selection component S and the tabular data. Additionally, the storage unit 204 stores a calculation result during processing and the like.

### <Decomposition of Ordered Record Selection Component S>

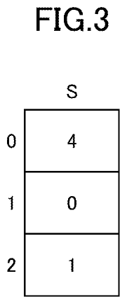

In the following, as an example, a case in which an ordered record selection component S₍₃₎⁽⁶⁾=(4, 0, 1) illustrated in FIG. 3 is given, and the ordered record selection component S₍₃₎⁽⁶⁾ is decomposed will be described. Here, for example, a user can suitably select which method is used for decomposition among the methods for the case of n˜N and the case of n<<N.

### <<Case of n˜ N>>

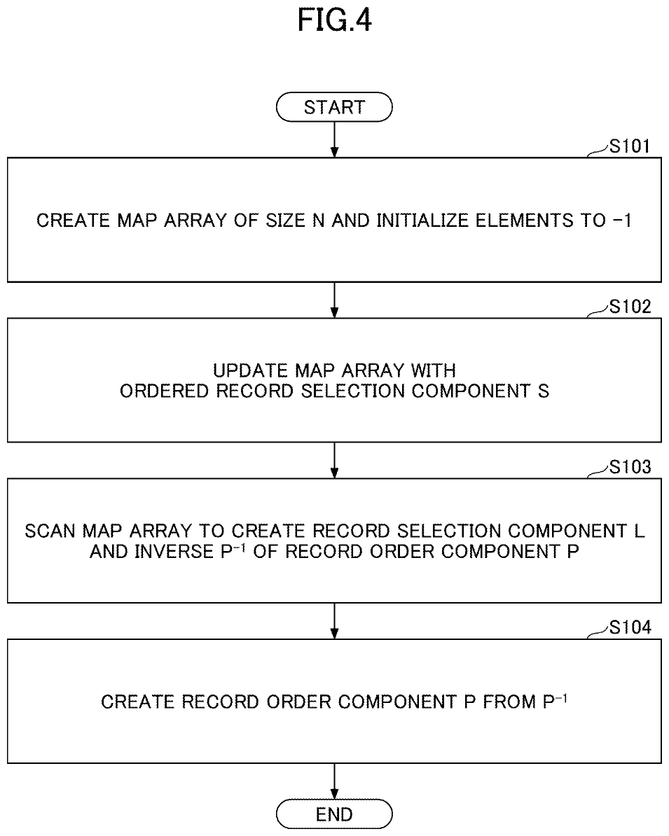

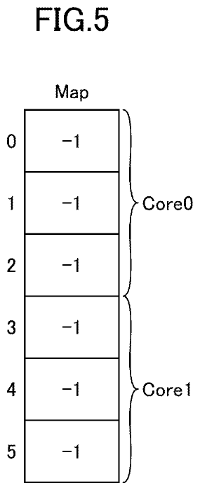

A process of decomposing the ordered record selection component S₍₃₎⁽⁶⁾=(4, 0, 1) in the case of n˜N will be described with reference to FIG. 4. This process can be performed in the order of O(n) time complexity.

First, the decomposing unit 201 creates a Map array having a size N(=6), and initializes each of the elements thereof to −1 (step S101). FIG. 5 illustrates the Map array having the size N=6 in which each of the elements is initialized to −1. Hereinafter, the Map array is also referred to as Map. Here, it is assumed that the processor 105 included in the index calculation device 10 according to the present embodiment is a multi-core processor, and hereinafter, elements in a range from the position 0 to the position 2 of the Map array are set as processing targets of Core 0, and elements in a range from the position 3 to the position 5 are set as processing targets of Core 1. This enables the subsequent processes to be performed in parallel in Core 0 and Core 1. Here, this is merely an example, and when the processor 105 is a multi-core CPU having three or more cores, three or more ranges may be set as targets for parallel processing.

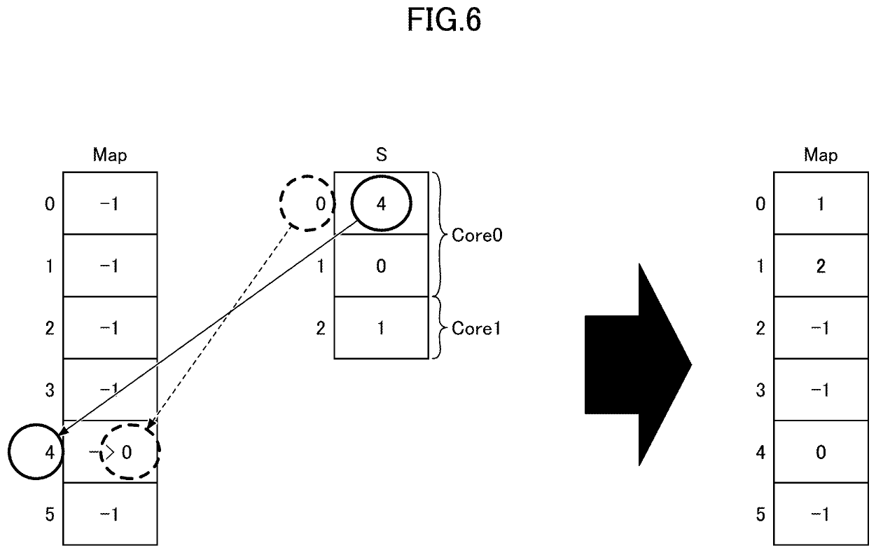

Next, the decomposing unit 201 updates the Map array with the ordered record selection component S₍₃₎⁽⁶⁾=(4, 0, 1) (step S102). Specifically, when S[i]=j, the decomposing unit 201 updates the Map array to Map [j]=i. At this time, the Map array can be updated in parallel by dividing the ordered record selection component S₍₃₎⁽⁶⁾ into the processing target of Core 0 and the processing target of Core 1. For example, elements in a range from the position 0 to the position 1 of S₍₃₎⁽⁶⁾ can be set as the processing targets of Core 0, and an element in the position 2 can be set as the processing target of Core 1. This is illustrated in FIG. 6. As illustrated in FIG. 6, Map=(1, 2, −1, −1, 0, −1) is obtained by this update.

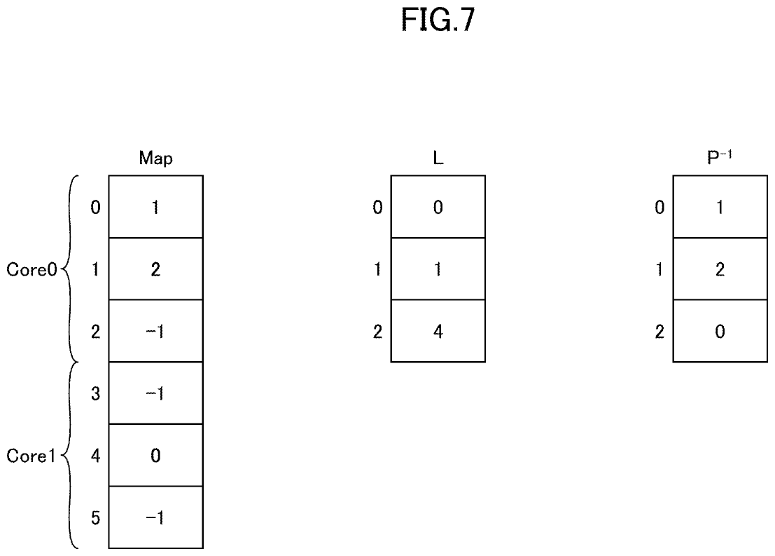

Next, the decomposing unit 201 scans the Map array to create the record selection component L and an inverse P⁻¹ of the record order component P (step S103). Specifically, the decomposing unit 201 scans each element of the Map array to determine whether each element satisfies Map[i] ≈−1, and sets a list of i satisfying Map [i]≈−1 as the record selection component L and a list of Map[i] satisfying Map [i]≈−1 as the inverse P⁻¹ of the record order component P. At this time, a scan in the range from the position 0 to the position 2 of the Map array and a scan in the range from the position 3 to the position 5 of the Map array are respectively performed by Core 0 and Core 1 in parallel. This is illustrated in FIG. 7. As illustrated in FIG. 7, the record selection component L=(0, 1, 4) and the inverse P⁻¹=(1, 2, 0) of the record order component P are obtained by this scanning.

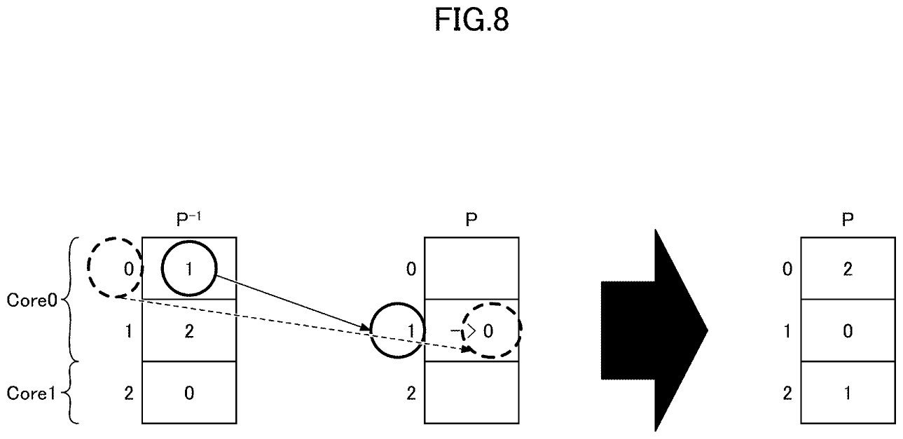

The decomposing unit 201 then creates the record order component P from P⁻¹ (step S104). Specifically, the decomposing unit 201 creates the record order component P by P [j]=i for P⁻¹ [i]=j. At this time, elements P⁻¹ [i]=j corresponding to the range from the position 0 to the position 2 of the Map array and elements P⁻¹ [i]=j corresponding to the range from the position 3 to the position 5 of the Map array are respectively generated in parallel by Core 0 and Core 1. This is illustrated in FIG. 8. As illustrated in FIG. 8, P [j]=i is created by Core 0 at the positions 0 to 1 of P⁻¹ and by Core 1 at the position 2, and P=(2, 0, 1) is obtained.

As described above, L₍₃₎⁽⁶⁾=(0, 1, 4) and P₍₃₎⁽⁶⁾=(2, 0, 1) are obtained. Because L₍₃₎⁽⁶⁾ and P₍₃₎⁽⁶⁾ are expressed as S₍₃₎⁽⁶⁾=L₍₃₎⁽⁶⁾·P₍₃₎⁽⁶⁾, it is found that S₍₃₎⁽⁶⁾ is decomposed. Therefore, in the case of n˜N, the ordered record selection component S can be decomposed into the record selection component L and the record order component P in the order of O(n) time complexity, and it is found that high-speed decomposition can be achieved.

<<Case of n<<N>>

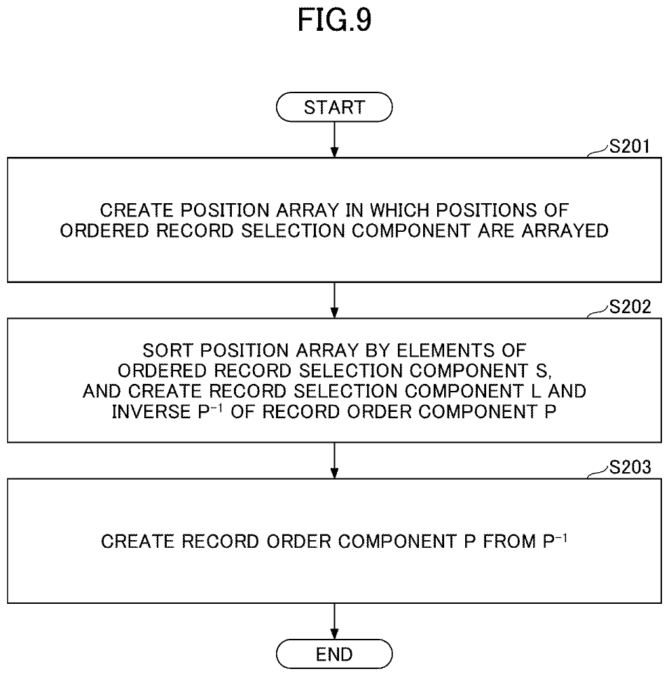

A process of decomposing the ordered record selection component S₍₃₎⁽⁶⁾=(4, 0, 1) when n<<N will be described with reference to FIG. 9. This process can be performed in the order of O(n×log (n)) time complexity.

First, the decomposing unit 201 creates a position array Pos in which positions of the ordered record selection component S₍₃₎⁽⁶⁾ are arrayed (step S201). That is, the decomposing unit 201 creates Pos=(0, 1, 2).

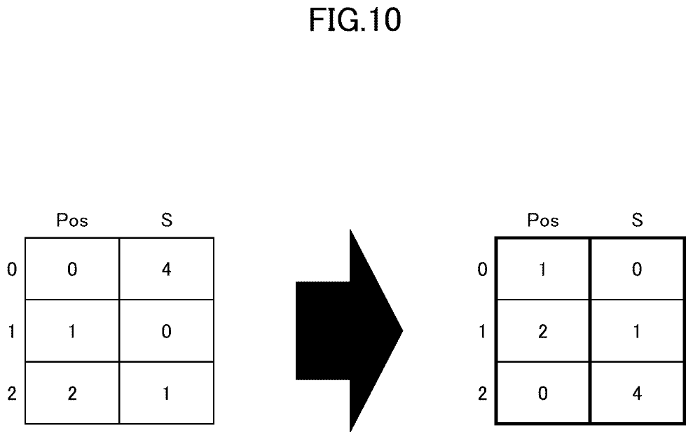

Next, the decomposing unit 201 sorts (sorts in ascending order) the position array by the elements of the ordered record selection component S, and creates the record selection component L and the record order component P (step S202). The sorting is illustrated in FIG. 10. As illustrated in FIG. 10, Pos=(0, 1, 2) is sorted in ascending order by the elements of the ordered record selection component S=(4, 0, 1), and Pos=(1, 2, 0) and the ordered record selection component S=(0, 1, 4) after the sorting are obtained. Pos=(1, 2, 0) after the sorting is P⁻¹, and S=(0, 1, 4) after the sorting is L.

The decomposing unit 201 then creates the record order component P from P⁻¹ (step S203). Specifically, the decomposing unit 201 creates the record order component P by P [j]=i for P⁻¹ [i]=j. With this, P=(2, 0, 1) is obtained.

As above, L₍₃₎⁽⁶⁾=(0, 1, 4) and P₍₃₎⁽⁶⁾=(2, 0, 1) are obtained. Because L₍₃₎⁽⁶⁾ and P₍₃₎⁽⁶⁾ are expressed as S₍₃₎⁽⁶⁾=L₍₃₎⁽⁶⁾·P₍₃₎⁽⁶⁾, it is found that S₍₃₎⁽⁶⁾ is decomposed. Therefore, it is found that, in the case of n<<N, the ordered record selection component S is decomposed into the record selection component L and the record order component P in the order of O(n×log (n)) time complexity, and high-speed decomposition can be achieved, although it is inferior to the case of n˜ N.

<Creation of Reverse Sort Pₛ⁻¹ and Application of Thereof>

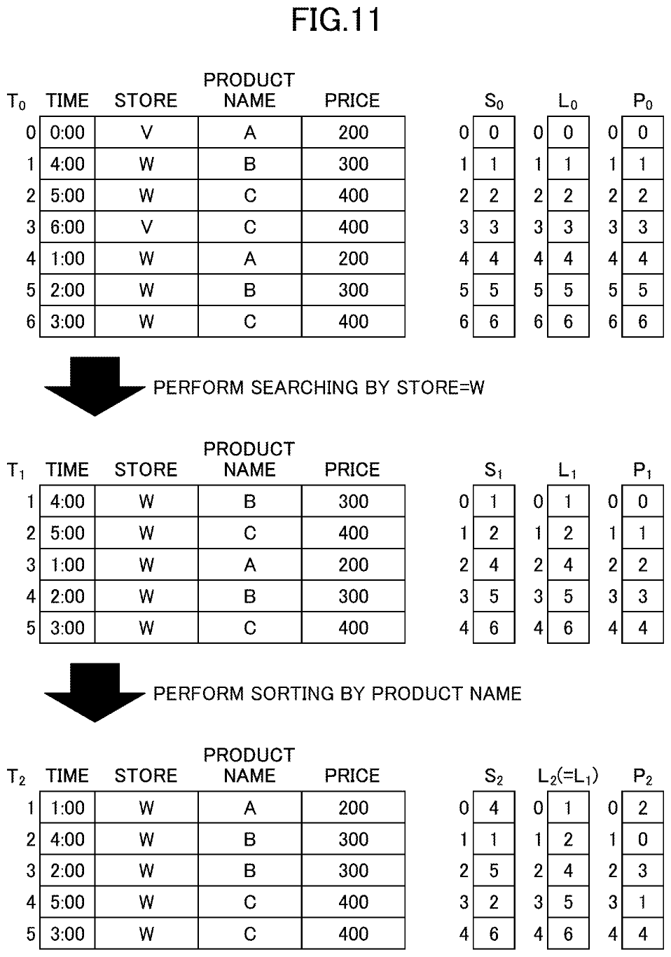

The following description assumes that, as an example, as illustrated in FIG. 11, a table T₀, which is tabular data having “time”, “store”, “product name”, and “price” as columns, is stored in the storage unit 204, and the table T₀ is searched for a record of “store”=W and sorted by “product name”. Here, a result of searching the table T₀ for the record of “store”=W is referred to as a table T₁, and a result of sorting records of the table T₀ by “product name” is referred to as a table T₂. Additionally, an ordered record selection component corresponding to the table Ti is represented as Si, a record selection component is represented as Li, and a record order component is represented as Pi.

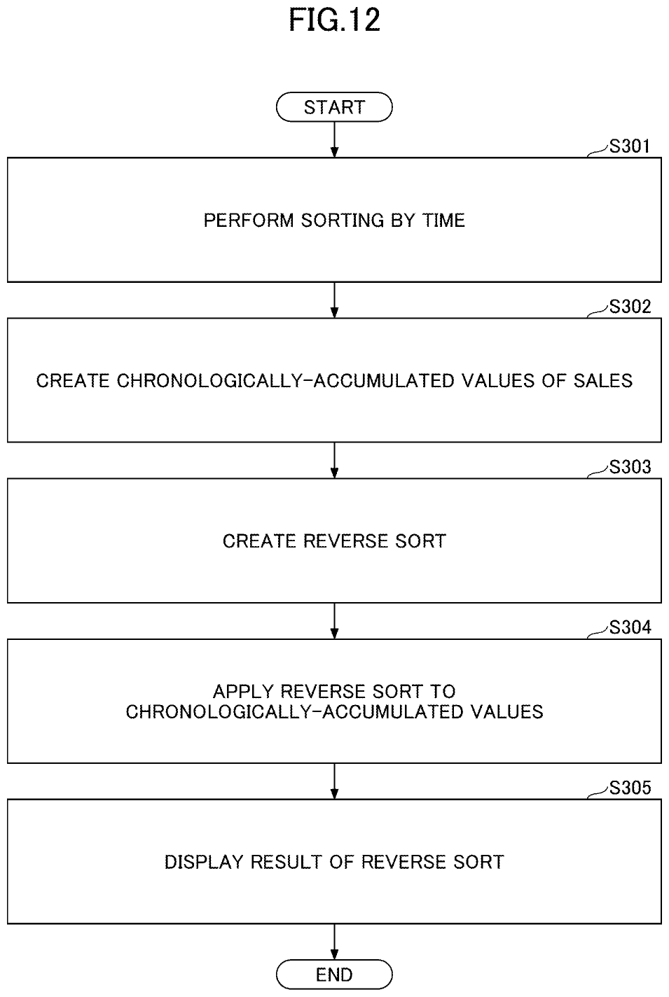

In the following, a case where the table T₂ is displayed by the display control unit 203 and the display of the chronologically-accumulated values indicating accumulated values of the sales in the order of time is achieved by the reverse sorting while the display is maintained will be described. A process for achieving such display will be described with reference to FIG. 12.

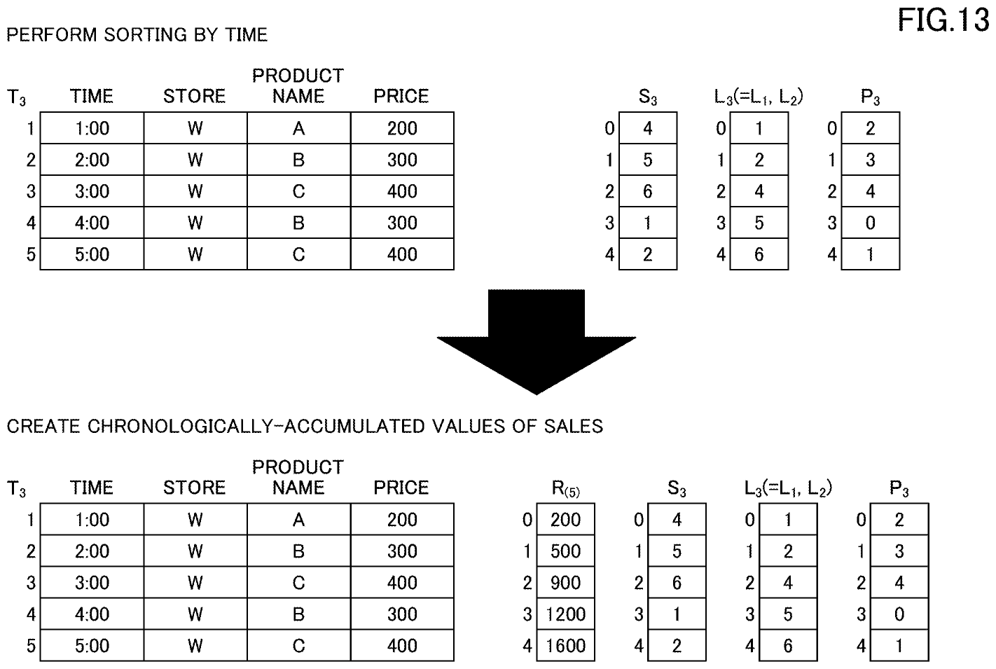

First, the reverse sorting unit 202 sorts (sorts in ascending order) the records in the table T₂ by time (step S301). It should be noted that the display by the display control unit 203 is the table T₂ as is. As a result of this sorting, the table T₃ illustrated in FIG. 13 is obtained. Additionally, an ordered record selection components S₃, a record selection component L₃, and a record order component P₃ are obtained.

Here, the sorting in step S301 above is the sort Pₛ from P₂ to P₃.

Next, the reverse sorting unit 202 creates the chronologically-accumulated values of sales by summing up the sales of respective records of the table T₃ in the order of time (step S302). It should be noted that the display by the display control unit 203 is the table T₂ as is. Hereinafter, a one-dimensional array having the chronologically-accumulated values as elements is referred to as R₍₅₎, and is called a chronologically-accumulated value array. As illustrated in FIG. 13, R₍₅₎=(200, 500, 900, 1200, 1600). With this, the chronologically-accumulated value array R(5) is obtained.

Next, the reverse sorting unit 202 creates the reverse sort Pₛ⁻¹ for the sort Pₛ in step S301 above (step S303). That is, the reverse sorting unit 202 creates the reverse sort Pₛ⁻¹ by Pₛ⁻¹=P₃⁻¹·P₂. Here, Pₛ⁻¹=P₃⁻¹·P₂=(3, 4, 0, 1, 2)·(2, 0, 3, 1, 4)=(0, 3, 1, 4, 2).

Next, the reverse sorting unit 202 applies the reverse sort Pₛ⁻¹ to the chronologically-accumulated value array R₍₅₎ (step $304). With this, a one-dimensional array R′₍₅₎=R₍₅₎·Pₛ⁻¹=(200, 500, 900, 1200, 1600)·(0, 3, 1, 4, 2)=(200, 1200, 500, 1600, 900), representing a result of the reverse sorting of the chronologically-accumulated value array is obtained.

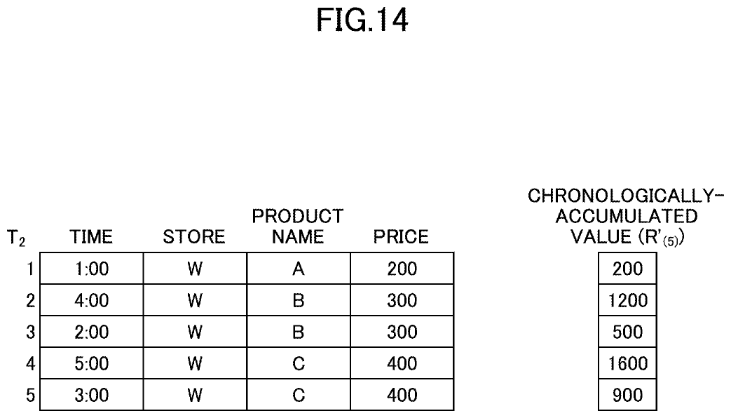

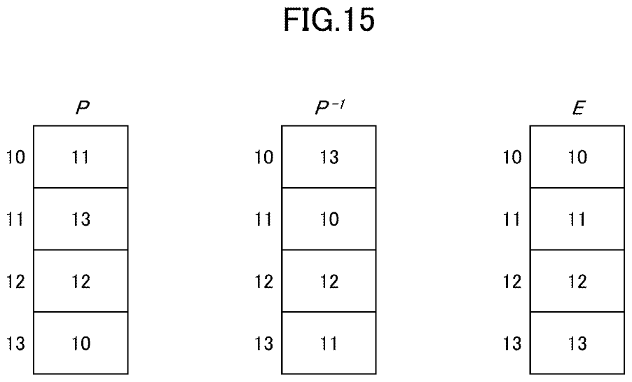

The display control unit 203 displays the one-dimensional array R′₍₅₎ obtained in step $304 together with the table T₂ (step S305). The display result is illustrated in FIG. 14. As illustrated in FIG. 14, the chronologically-accumulated values can be displayed in a form corresponding to the table T₂. As described above, by using the reverse sort Pₛ⁻¹, various values calculated by using the sort Pₛ can be displayed in the same order as the table before the sort Pₛ.

### <Base of Symmetrical Array>

In the above description, the case where with respect to the array used for the natural number index, a base of the array is 0 (that is, the storage position of the array starts from 0) has been described, but the index operator can be defined in the same manner between one-dimensional arrays other than a base-0 array. With respect to the index calculation between the one-dimensional arrays other than the base-0 array, a group is similarly formed when the arrays are a symmetric array.

That is, when a base is represented by Q (Q is an arbitrary integer), an index calculation between symmetric arrays of the base Q is a group operation, a linkage rule is satisfied, an identity element exists, and an inverse of the identity element exists for an arbitrary symmetric array of the base Q. For example, when a symmetric array P=(11, 13, 12, 10) of the base 10 as illustrated in FIG. 15 is considered, an inverse is P⁻¹=(13, 10, 12, 11) and an identity element is E=(10, 11, 12, 13).

When the base is represented by Q, the definition of the complete sequential number N can be expanded to “sequential natural numbers from Q to Q+N−1-”. Thus, the definition of the complete sequential number N array can be similarly extended. That is, a one-dimensional array A^{(N)} of the base Q being the complete sequential number N array can be expanded to “a value of an arbitrary element A^{(N)} [i] is any of Q to Q+N−1”.

### <Conclusion>

As described above, when the ordered record selection component S₍ₙ₎^{(N)} is given, the index calculation device 10 according to the present embodiment can decompose the ordered record selection component S₍ₙ₎^{(N)} into S₍ₙ₎^{(N)}=L₍ₙ₎^{(N)}·P₍ₙ₎⁽ⁿ⁾. Moreover, when n˜ N, the decomposition can be performed in the order of O (n) time complexity, and even when n<<N, the decomposition can be performed in the order of O(n×log (n)) time complexity. Therefore, an algorithm group for realizing various operations (for example, search, sort, aggregation, relational algebra operation, and the like) in the natural number index can be performed at high speed.

Additionally, the index calculation device 10 according to the present embodiment can calculate the reverse sort Pₛ⁻¹ for the sort Pₛ from P₁ to P₂ with respect to arbitrary record order components P₁ and P₂ ∈G. Thus, various applications using the reverse sort Pₛ⁻¹ can be realized. For example, when it is desired that after the sort Pₛ is performed on a column of the tabular data, the accumulated values of the column are obtained and displayed together with the tabular data before the sort Pₛ, the accumulated value can be displayed in the same order as the record order of the tabular data before the sort Pₛ by performing the reverse sort Pₛ⁻¹ on the accumulated value.

The present invention is not limited to the above-described embodiment specifically disclosed, and various modifications, changes, combinations with known techniques, and the like can be made without departing from the description of the claims.

What is claimed is:

1. A calculation device comprising:
a processor; and
a memory storing program instructions that cause the processor to:
decompose an ordered record selection component S₍ₙ₎^{(N)} into a record selection component L₍ₙ₎^{(N)} and a record order component P₍ₙ₎⁽ⁿ⁾, the ordered record selection component S₍ₙ₎^{(N)} being an ordered set including n (0≤n≤N) elements selected from a record number set including integers from Q to Q+N−1 (Q is a predetermined integer and N is a predetermined integer greater than or equal to 1), the record selection component L₍ₙ₎^{(N)} being a set including n elements selected from the record number set, and the record order component P₍ₙ₎⁽ⁿ⁾ representing an order of the elements of the record selection component L₍ₙ₎^{(N)},
wherein the program instructions cause the processor to decompose the ordered record selection component S₍ₙ₎^{(N)} by using a predetermined operation between the record selection component L₍ₙ₎^{(N)} and the record order component P₍ₙ₎⁽ⁿ⁾.

2. The calculation device as claimed in claim 1, wherein the program instructions cause the processor to decompose the ordered record selection component S₍ₙ₎^{(N)} by using an inverse of the record order component P₍ₙ₎⁽ⁿ⁾.

3. The calculation device as claimed in claim 2, wherein the program instructions cause the processor to sort storage positions of a one-dimensional array in which elements of the ordered record selection component S₍ₙ₎^{(N)} are stored, in ascending order of the elements of the ordered record selection component S₍ₙ₎^{(N)}, create, by using the sorted storage positions as the inverse, the record order component P₍ₙ₎⁽ⁿ⁾ from the inverse, and set the sorted ordered record selection component S₍ₙ₎^{(N)} as the record selection component L₍ₙ₎^{(N)}.

4. The calculation device as claimed in claim 2, wherein the program instructions cause the processor to update a Map array having a size N with elements of the ordered record selection component S₍ₙ₎^{(N)}, and create the record selection component L₍ₙ₎^{(N)} and the inverse by scanning the updated Map array, and create the record order component P₍ₙ₎⁽ⁿ⁾ from the inverse.

5. The calculation device as claimed in claim 4,
wherein the processor is a multi-core central processing unit,
wherein the program instructions cause the processor to set processing ranges of the Map array for respective cores, and
wherein the program instructions cause the cores of the processor to process the scanning, the creation of the inverse, and the creation of the record order component P₍ₙ₎⁽ⁿ⁾ in parallel.

6. The calculation device as claimed in claim 1, wherein the program instructions cause the processor to decompose the ordered record selection component S₍ₙ₎^{(N)} as S₍ₙ₎^{(N)}=L₍ₙ₎^{(N)}·P₍ₙ₎⁽ⁿ⁾ by using· as the predetermined operation.

7. The calculation device as claimed in claim 6, wherein the predetermined operation · is defined by A·B=(A[B[Q+0]], A[B[Q+1]], . . . , A[B[Q+m−1] ]), for a one-dimensional array A=(A[Q+0], A[Q+1], . . . , A[Q+n−1]) representing an arbitrary set having n elements and a one-dimensional array B=(B[Q+0], B[Q+1], . . . , B[Q+m−1]) representing an arbitrary set including values from Q to Q+n−1 and having m elements.

8. The calculation device as claimed in claim 1,
wherein the record order component represents a permutation for {Q+0, Q+1, . . . , Q+n−1}, and
wherein the program instructions cause the processor to calculate a reverse sort Pₛ⁻¹ that is an inverse of a sort Pₛ representing a permutation from a record order component P₁ to a record order component P₂.

9. The calculation device as claimed in claim 8, wherein the program instructions cause the processor to perform the reverse sort Pₛ⁻¹ on a result calculated by performing the sort Pₛ and the predetermined operation on a given one-dimensional array.

10. The calculation device as claimed in claim 1, wherein Q is 0.

11. A calculation method comprising:
decomposing an ordered record selection component S₍ₙ₎^{(N)} into a record selection component L₍ₙ₎^{(N)} and a record order component P₍ₙ₎⁽ⁿ⁾, the ordered record selection component S₍ₙ₎^{(N)} being an ordered set including n (0≤n≤N) elements selected from a record number set including integers from Q to Q+N−1 (Q is a predetermined integer and N is a predetermined integer greater than or equal to 1), the record selection component L₍ₙ₎^{(N)} being a set including n elements selected from the record number set, and the record order component P₍ₙ₎⁽ⁿ⁾ representing an order of the elements of the record selection component L₍ₙ₎^{(N)},
wherein the decomposing includes decomposing the ordered record selection component S₍ₙ₎^{(N)} by using a predetermined operation between the record selection component L₍ₙ₎^{(N)} and the record order component P₍ₙ₎⁽ⁿ⁾.

12. A non-transitory computer-readable recording medium having stored therein a program for causing a computer to perform a process comprising:
decomposing an ordered record selection component S₍ₙ₎^{(N)} into a record selection component L₍ₙ₎^{(N)} and a record order component P₍ₙ₎⁽ⁿ⁾, the ordered record selection component S₍ₙ₎^{(N)} being an ordered set including n (0≤n≤N) elements selected from a record number set including integers from Q to Q+N−1 (Q is a predetermined integer and N is a predetermined integer greater than or equal to 1), the record selection component L₍ₙ₎^{(N)} being a set including n elements selected from the record number set, and the record order component P₍ₙ₎⁽ⁿ⁾ representing an order of the elements of the record selection component L₍ₙ₎^{(N)},
wherein the decomposing includes decomposing the ordered record selection component S₍ₙ₎^{(N)} by using a predetermined operation between the record selection component L₍ₙ₎^{(N)} and the record order component P₍ₙ₎⁽ⁿ⁾.
